(19) United States
(12) Patent Application Publication
(10) Pub. No.: US 2012/0011565 A1
(43) Pub. Date: Jan. 12, 2012

(54) SYSTEM AND METHOD FOR STORING AND PROVIDING ACCESS TO SECURED INFORMATION

(76) Inventors: James M. Garlie, Las Vegas, NV (US); Don Hesskamp, N. Las Vegas, NV (US)

(21) Appl. No.: 13/161,991

(22) Filed: Jun. 16, 2011

Related U.S. Application Data
(60) Provisional application No. 61/361,813, filed on Jul. 6, 2010.

(51) Int. Cl. G06F 7/04

(52) U.S. Cl. 726/2

(57) ABSTRACT

The embodiments of the present invention relate to an electronic transfer and storage system implemented in a medical records environment or application using a card with memory capabilities and biometric (includes finger, palm, iris, facial photo, scent, voice recognition and other biometric attributes) data to authenticate the account holder (patient, nurse, Doctor, Pharmacist, EMS or EMT). With such a card, reader and system, a patient is able to be enrolled with a physician using biometric input for authentication.

### RELATED APPLICATIONS

The present application claims priority to U.S. Provisional Patent Application Ser. No. 61/361,813, filed Jul. 6, 2010, which is hereby incorporated by reference in its entirety.

### FIELD OF INVENTION

The present invention relates generally to providing secured access to private information, and more particularly, to a system and method for storing private information on a portable storage device controllably providing access thereto by authorized users.

### BACKGROUND OF INVENTION

In today's world, providing secure access to only authorized users, while restricting access from unauthorized users is increasingly important.

For example, in today's medical industry or profession a patient's care is limited to a Doctor's and or other medical professional's ability to access the patient's medical records. The most popular means of accessing a patient's medical records isn't so popular or convenient. In many cases accessing a patient's medical records may involve engaging legal services.

The Department of Health and Human Services (HHS) enacted the Health Insurance Portability and Accountability ACT of 1996 (HIPAA) to insure that personal information stored, accessed, or posses adheres to a set of guidelines or “security rules”. These rules outline security measures that should be implemented to secure all electronic protected health information (EPHI). The Secretary of Health and Human Services enforces this law. Non-compliance can lead to civil monetary penalties and public distrust. The collection, management, and analysis of log data is integral to meeting HIPAA requirements.

There is also a set of international standards. Health Level Seven (HL7), the most commonly used health care standard in the world, is an international health care standard for the exchange, integration, sharing, and retrieval of electronic health information, which support clinical practice and the management, delivery, and evaluation of health services.

Presently, medical records are not portable. It is impossible to directly share information about a patient's history. If a patient is seeing more than one physician, one physician may not be aware of the existence of the other physician, and what is being treated. This can cause tests to be duplicated. Treatments can run counter to each other. Drugs can be prescribed that have dangerous interactions. Doctors can be shopped for prescriptions. Pharmacies may not be able to clearly read prescriptions, leading to incorrectly filled prescriptions. Prescription forms can be forged or stolen. Payments to doctors can be delayed or not made at all. Unscrupulous providers can bill for non-existent patients or double bill for patients.

There are electronic medical record systems available right now, but they are not portable and do nothing to solve security problems. They exist primarily to make the Doctor's office operate more efficiently. Emergency responders, whether they are Doctor's or EMS or EMT personal, have no information regarding the patient.

Thus, there is a need for a portable medical card, reader and system that is compliant with the Health Insurance Portability and Accountability ACT of 1996 (HIPAA) to secure all electronic protected health information (EPHI) and that complies with Health Level Seven (HL7).

### SUMMARY OF THE INVENTION

In a first aspect of the present invention, biometric data (finger, palm, iris, facial photo, scent, voice recognition and other biometric attributes) may be used to authenticate a patient to allow access to his or her medical records.

In a second aspect of the present invention, biometric data may be used to authenticate a Doctor to allow access to a patient's medical records.

In a third aspect of the present invention, biometric data may be used to authenticate a Pharmacist to allow access to a patient's medical records.

In a fourth aspect of the present invention, biometric data may be used to authenticate a Registered Nurse, or other qualified medical professional, to allow access to a patient's medical records.

In a fifth aspect of the present invention, biometric data may be used to authenticate any of the above mentioned professionals or any combination of the above mentioned professionals to allow access to a patient's medical records.

In a sixth aspect of the present invention, biometric data may be used to authenticate a patient to allow access to his or her medical records by any of the above mentioned professionals or any combination of the above mentioned professionals.

In a seventh aspect of the present invention, biometric data may be used to authenticate a patient to allow access to his or her medical records by any of the above mentioned professionals or any combination of the above mentioned professionals and using biometric data to authenticate any of the above mentioned professionals or any combination of the above mentioned professionals to allow access to a patient's medical records.

In a seventh aspect of the present invention, biometric data may be used to authenticate a patient to allow access to his or her medical records by any of the above mentioned professionals or any combination of the above mentioned professionals and using biometric data to authenticate any of the above mentioned professionals or any combination of the above mentioned professionals to allow access to a patient's medical records, that comply with the Health Insurance Portability and Accountability ACT of 1996 (HIPAA) to insure that personal information stored, accessed, or posses that adheres to the set of guidelines or “security rules” that outline security measures that should be implemented to secure all electronic protected health information (EPHI).

In an eighth aspect of the present invention, biometric data may be used to authenticate a patient to allow access to his or her medical records by any of the above mentioned professionals or any combination of the above mentioned professionals and using biometric data to authenticate any of the above mentioned professionals or any combination of the above mentioned professionals to allow access to a patient's medical records, that comply with Health Level Seven's (HL7) international standards.

In a ninth aspect of the present invention, biometric data may be from an individual and or patient that is transferred from the individual and or patient to and through a biometric sensor or scanner, processor, biometric reader, card reader interface and card interface to a net-book or slate to a smart card and then also to a central office computer to a central database to the initial smart card. If the biometric data is required it will be requested by the card.

In a tenth aspect of the present invention, data that is not web based may be used for authentication.

In an eleventh aspect of the present invention, a method where the reader identifies itself to the card may be used.

In a twelfth aspect of the present invention, a method where the card identifies itself to the reader may be used.

In a thirteenth aspect of the present invention, a method where the type of reader used determines the level of memory access allowed may be used.

In a fourteenth aspect of the present invention, a method where the code identifying a reader changes on each use may be used.

In a fifteenth aspect of the present invention, a method where patient verification is done on the card, so that no verification information is exposed may be used.

In a sixteenth aspect of the present invention, a method for the mutual authentication of a plurality of cards may be used.

In a seventeenth aspect of the present invention, a method where the verification processor controls the biometric reader may be used.

In an eighteenth aspect of the present invention, a method where the verification processor can request different types of biometric authentication may be used.

In a nineteenth aspect of the present invention, a method where the verification processor controls the memory management processor may be used.

In a twentieth aspect of the present invention, a method where multiple cards will authenticate themselves to each other before any display of information begins may be used.

In a twenty-first aspect of the present invention, a method where the patient controls access to their personal records may be used.

In a twenty-second aspect of the present invention, a method where different biometric authentications control the release of records may be used.

In a twenty-third aspect of the present invention, a “Dog Tag” or basic identification memory may be used.

In a twenty-fourth aspect of the present invention, the inclusion of a code for the last procedure performed in the enhanced Dog Tag information may be used.

In a twenty-fifth aspect of the present invention, an enhanced “Dog Tag” memory for EMT/EMR technicians, which shows a synopsis of the patient's records without exposing the complete underlying records, may be used.

In a twenty-sixth aspect of the present invention, a prescription record that shows the patient's prescription history can be viewed by a pharmacist, may be used.

In a twenty-seventh aspect of the present invention, a method of electronically authenticating a prescription to a pharmacist may be used.

In a twenty-eighth aspect of the present invention, the storage of a patient's complete medical history where access is controlled by the patient may be used.

In a twenty-ninth aspect of the present invention, a secured mag-stripe that duplicates the “Dog Tag” function may be used.

In a thirtieth aspect of the present invention, a 2D or 3D barcode which contains the basic “DOG Tag” information that can be read by a smart phone or barcode reader may be used.

In a thirty-first aspect of the present invention, a method where the device, card or reader verifies its physical integrity may be used.

In a thirty-second aspect of the present invention, a method where the device, card or reader verifies its software integrity may be used.

In a thirty-third aspect of the present invention, a method where the device, card or reader authenticates itself to a base station may be used.

In a thirty-fourth aspect of the present invention, a method where the device, card or reader authenticates to other base stations, may be used.

In a thirty-fifth aspect of the present invention, a method where a doctor can access a patients records remotely may be used.

In a thirty-sixth aspect of the present invention, a method where a reader identifies itself to a card may be used.

In a thirty-seventh aspect of the present invention, a method where a reader identifies itself to a base station may be used.

In a thirty-eighth aspect of the present invention, a method where a reader authenticates itself to a patient's card may be used.

In a thirty-ninth aspect of the present invention, a method where a reader authenticates itself to a doctor's card may be used.

In a fortieth aspect of the present invention, a method where a reader authenticates itself to a hospital card may be used.

In a forty-first aspect of the present invention, a method where a readers identity sets its functionality may be used.

In a forty-second aspect of the present invention, a method for providing access to information stored on a portable storage device via a reader device is provided. The portable storage device stores information including user data associated with a user. The user data has a first portion and a second portion. The first portion is of a basic type and the second portion being of a second type. A storage device controller is located within the housing and is coupled to the memory storage. The method includes the following steps:
allowing the portable storage device to be inserted into a reader device;
sending a reader identification code from the reader device to the portable storage device in response to the portable storage device being inserted into the reader device;
receiving the reader identification code at the storage device controller, authenticating the reader device if the reader identification code is valid, and responsively ejecting the portable storage device if the reader identification code is not valid;
sending a portable storage device identification code from the portable storage device to the reader device;
receiving the portable storage device identification code at the reader device, authenticating the portable storage device if the portable storage device identification code is valid, and responsively ejecting the portable storage device if the portable storage identification code is not valid; and,
if the reader identification code and the portable storage device identification code are valid:
   providing access to the first portion of the user data stored on the portable storage device; and,
   receiving a request for the second portion of the information stored on the reader device by a requesting user, responsively requiring biometric authentication of the requesting user, and responsively providing access to the second portion of the user data stored on the portable storage device if the requesting user is authenticated.

In a forty-third aspect of the present invention, a method for providing access to medical records associated with a patient stored on a portable storage device via a card reader is provided. The card includes a memory storage for storing information. The medical records are associated with a user. The medical records has a first portion and a second portion. The first portion is of a basic type and the second portion is of a second type. A storage device controller is located within the housing and is coupled to the memory storage. The method includes the steps of:
allowing the card to be inserted into the card reader;
sending a reader identification code from the card reader to the card in response to the card being inserted into the card reader;
receiving the reader identification code at the storage device controller, authenticating the card reader if the reader identification code is valid, and responsively ejecting the card if the reader identification code is not valid;
sending a card identification code from the card to the card reader;
receiving the card identification code at the card reader, authenticating the card if the card identification code is valid, and responsively ejecting the card if the portable storage identification code is not valid; and,
if the reader identification code and the card identification code are valid:
   providing access to the first portion of the medical records stored on the portable storage device; and,
   receiving a request for the second portion of the information stored on the card reader by a requesting user, responsively requiring biometric authentication of the requesting user, and responsively providing access to the second portion of the medical records stored on the card if the requesting user is authenticated.

The embodiments of the present invention relate to an electronic transfer and storage system implemented in a medical records environment or application using a card with memory capabilities and biometric (includes finger, palm, iris, facial photo, scent, voice recognition and other biometric attributes) data to authenticate the account holder (patient, nurse, Doctor, Pharmacist, EMS or EMT). With such a card, reader and system, a patient is able to be enrolled with a physician using biometric input for authentication. The current art uses separate devices for biometric data entry, data display handwriting capture, secured bi-directional wireless communication and user authentication with limited or no device security.

Accordingly, a first embodiment of the present invention is a secure biometric system including a medical card with memory capabilities and reader with authentication and transfer capabilities, that makes medical records portable.

This invention combines the biometric data entry, data display and handwriting capture functions, with functions for device security, data encryption and decryption, mutual authentication of the doctor, patient, local wireless network and the wired network for communication with a remote base station within a single hand-held device. Other versions of this device may omit the handwriting capture, biometric data entry, user authentication and secure network communication functions.

The patient's complete history would be available to any physician. This would eliminate duplicated test. Treatments can run parallel with each other and work together. Since the patient's prescription history would be available the dangerous drug interactions can be reduced. The shopping of doctors can be reduced. Since prescription forms would not be used fraudulent prescriptions can be eliminated. The problem of pharmacies not being able to read prescriptions would be eliminated. Billing would be done at the time of the visit. This allows the doctor to be paid faster, and it also eliminates multiple billing and billing for non-existent patients. Since the records portable emergency responders would have information regarding the patient's blood type, allergies, and special conditions.

The SASI Med Card is unique in that it is not a web based solution, but a secured smart card solution. This card would hold all of a person's medical records in a bio-metrically secured fashion. The patient would maintain complete control over who has access to their detailed personal data. Since is all the information is contained in a card that the person has control of, which is bio-metrically linked to the person, identity theft and unwanted probing are virtually impossible. With a web based solution, theft and unwanted probing would be relativity easy. There is still a central data repository, but it is not on the web and would only be used as a backup if a card is damaged, lost or stolen.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1A is a graphical representation of a first side of a portable storage device in the form of a card, according to an embodiment of the present invention;

FIG. 2A is a graphical representation of a second side of the portable storage device of FIG. 1A;

FIG. 2 is a block diagram of a system for providing access to information stored on a portable storage device, according to an embodiment of the present invention;

FIG. 3A is a block diagram of a portable storage device, according to an embodiment of the present invention;

FIG. 3B is a block diagram of a reader device, according to an embodiment of the present invention;

FIG. 4 is a diagrammatic illustration of a system for storing private information on a portable storage device and a reader of a first type for controllably providing access thereto, according to an embodiment of the present invention;

FIG. 5 is a diagrammatic illustration of a system for storing private information on a portable storage device and a reader of a second type for controllably providing access thereto, according to an embodiment of the present invention;

FIG. 6 is a diagrammatic illustration of a system for storing private information on a portable storage device and a reader of a third type for controllably providing access thereto, according to an embodiment of the present invention;

FIG. 7 is a diagrammatic illustration of a system for storing private information on a portable storage device and a reader of a fourth type for controllably providing access thereto, according to an embodiment of the present invention;

FIG. 8 is a flow diagram of a method for providing access to private information storage on a portable storage device, according to an embodiment of the present invention;

FIG. 9 is a first flow diagram of a method for providing access to private information storage on a portable storage device, according to an other embodiment of the present invention;

FIG. 10 is a second flow diagram of the method of FIG. 9;

FIG. 11A is a first portion of a third flow diagram of the method of FIG. 9;

FIG. 11B is a second portion of the third flow diagram of the method of FIG. 9;

FIG. 12A is a first portion of a flow diagram of a method for initializing a reader device, according to an embodiment of the present invention; and,

FIG. 12B is a second portion of the flow diagram of FIG. 12A.

### DETAILED DESCRIPTION OF THE INVENTION

With reference to the drawings, and in operation, the present invention provides a system 10 and method 80, 90, 100, 110, 120 for securely storing and providing access to information.

In one aspect of the present invention, the information is stored on a portable storage device 12. In one embodiment the portable storage device 12 is in the form of a card 12. The card 12 generally, may be similar in size to a credit card or smart card.

The information stored in the system 10 may, in general, be any type of data which the user may want to be secured or kept private, and to which limited persons have access thereto. For example, the information secured by the present invention may include medical information or records. Specifically, in the disclosed embodiment, the portable storage device 12, which is in the form of a card, is associated with a patient (not shown). The patient's card 12 is generally kept and maintained by the patient, and carries that patient's medical records.

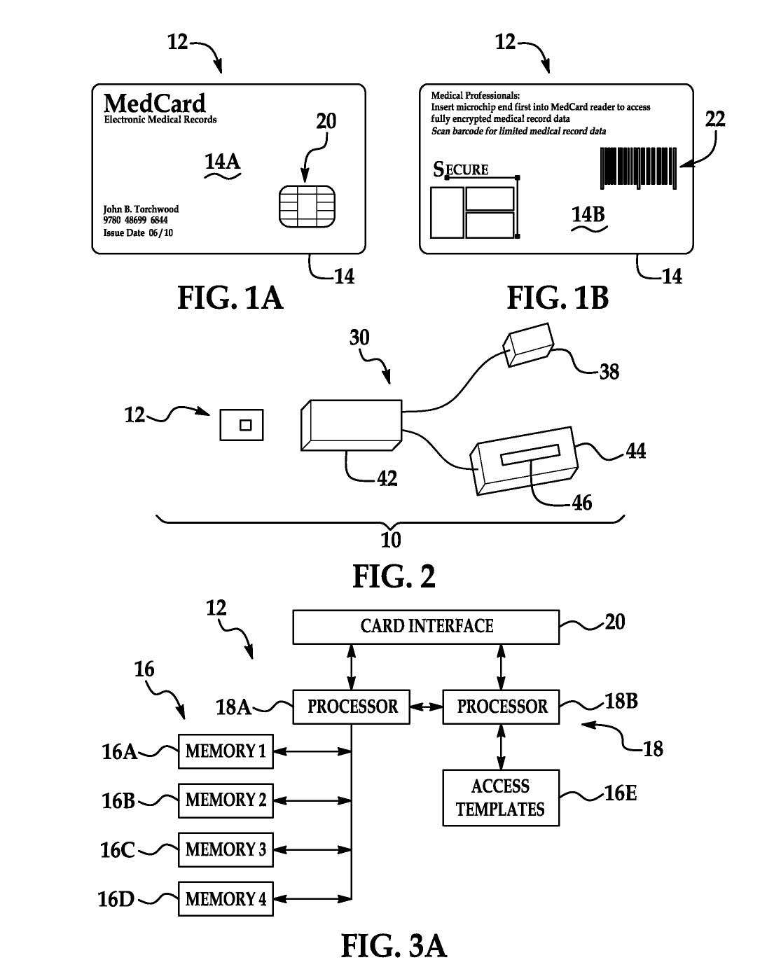

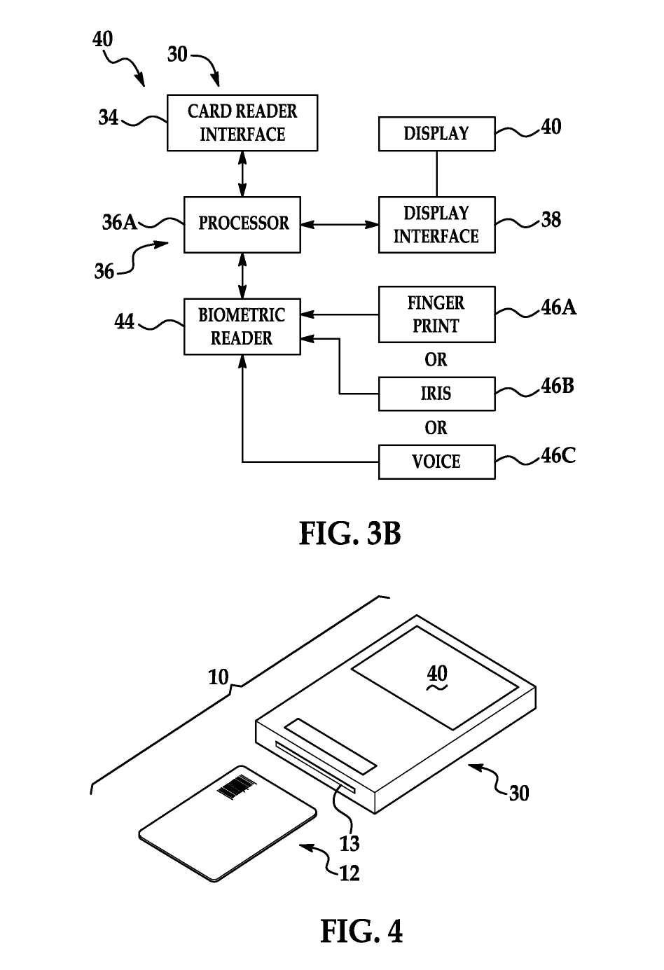

With particular reference to FIGS. 1A, 1B, and 3A, the portable storage device 12 has a housing 14. The housing 14 has a first side 14A shown in FIG. 1A and a second side 14B shown in FIG. 1B. The first side 14A includes a portable storage device interface 20, which in the illustrated embodiment, is in the form of a plurality of electrical contacts 20 (see below). The second side 14B includes a machine readable code 22, such as a barcode or a QR code, which can be read by standard (barcode or QR) readers to obtain limited medical record data. This limited medical record may be referred to as “dog tag data or dog tag level data”.

It should be noted that the portable storage device or card 12 may be used as a secured ID card and may be used to replace existing paper or plastic ID cards.

As discussed more fully below, the portable storage device 12 may be read by a specialized reader device 30. With particular reference to FIGS. 2 and 3B, the reader device 30 generally includes a reader 42 for reading the data or information from the portable storage device 12. Authentication for access to secured information is provided through a biometric reader 44.

The biometric reader 44 may include one or more biometric sensors 46 for sensing a biometric parameter of a user, such as a fingerprint 46A, voice 46B, or iris of the eyeball 46C of the user. A display interface 38 couples the reader 42 to a display 40. Data related to the sensed biometric parameter of the user is transferred from the sensor 46 to a reader controller 36, then transferred to the portable data storage device 12 through the card reader interface 34. The reader controller 36 may include a processor 36A.

In general, once a user is authenticated by a comparison of the sensed biometric parameter with access template data 16E, some of the information stored on portable storage device 12 is transferred to the reader device 30 and displayed on the display 40.

With particular reference to FIG. 3A, the portable storage device 12 includes a controller 18 which communicates to the reader 30 via the card interface 20. The portable storage device 12 includes memory 16, 16A, 16B, 16C, 16D for storing the information and one or more access templates 16E. The access templates 16 are biometric templates which are compared with the data from the biometric sensor 46 to confirm or authorize the user (see below).

The memory 16 may be dedicated or shared memory. In the graphical illustration of FIG. 3A, the memory 16 is represented by memory 1 16A, memory 2 16B, memory 3 16C, and memory 4 16D. Each representation 16A, 16B, 16C, 16D may be associated with a specific data type, but may or may not represent an actual, physical predetermined memory locations. The memory 16 may be embodied in a single memory device or several devices. In one embodiment different portions of the data may be stored in dynamically allocated portions of the memory 16.

The controller 18 and memory 16 are generally contained within the portable storage device housing 14. The controller 18 controls access to the memory 16, i.e., reads the information from the memory 16 and provides to the reader device 30, and compares the biometric data from the reader device 30 with the template data 16E. In the illustrated embodiment, the controller 18 includes a first processor 18A and a second processor 18B. The first processor 18A reads and writes to memory 16A, 16B, 16C, 16D, while the second processor 18B accesses memory 16E and authenticates the user by comparing the biometric data with the template data 16E. It should be noted, however, that the controller 18 may include a single processor.

With reference to FIG. 4, a graphical illustration of the system 10 includes a card 12 and the reader 30, according to a first embodiment of the present invention.

In general, the card 12 may include multiple types of data, each of which may require a different type or level of authentication. In other words, each level or type of data may be accessed by authorized levels of an associated levels. Higher levels of users may, however, access lower levels of types of data.

In one embodiment, when the card 12 is inserted into the reader device 30, contact is made through the card interface 34, which provides electrical power to the storage device 12. The reader controller 36 then provides its identification (ID code) to the storage device controller 18, which then sets the access level on the storage device controller 18 or memory processor 18A based on information stored on access template 16E. The memory processor 18A accesses the identified memory 16A, 16B, 16C, 16D and transfers the associated information over the card interface 20 to the reader device 30, which then transfers the encrypted data to the display device 40 via the connection 34.

If a higher level of access is required, the portable storage device controller 18 sends a request for biometric information over the card interface 20 via the card reader interface 34 to the reader controller 36 which enables the biometric reader 44. The biometric information entered through the biometric sensor(s) 46 is streamed through the controller 36 via the card interface 34 to the storage device controller 18 where it is verified against the access template 16E, which then sets the access level on storage device controller 18 for memory 1, memory 2, memory 3, an memory 4 16A, 16B, 16C, 16D.

In one embodiment, information transferred and communication between the storage device 12 and the reader device 30 is encrypted.

The reader device 30 shown in FIG. 4, may be setup or configured to be used by any type or level of user. Every authorized user would have template data stored in memory 16E. Unauthorized users may be able to access the basic data, i.e., the dog tag data. Authorized users may be added to the access templates 16E, generally with the authorization of the patient. For example, if the patient goes to new doctor's office, the templates for the authorized users at the new doctor's office may be downloaded and stored in the access templates portion of memory 16. It should be noted that each of the new authorized users would have a specified or associated level or type which provides an appropriate level of access to the information. For example, an accounting or administrative user may have access to insurance information stored on the device 12, while an admitting nurse may have access to the insurance information and a first level of secured medical information. The doctors in the new office may have access to the first level of secured medical information and a second level of secured medical information. All users may have access to the basic or dog tag level of information.

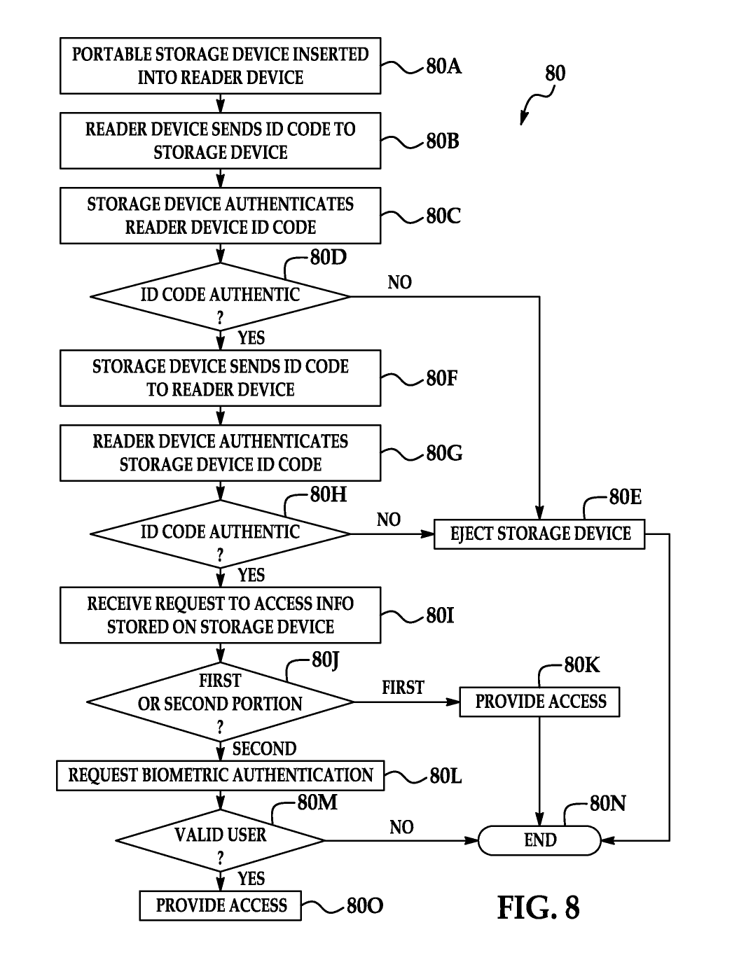

With specific reference to FIG. 8, in one embodiment of the present invention a method 80 provides access to the information stored on a portable storage device 12. For purposes of discussion, the information stored on the portable storage device 12 is divided into two portions. The first portion is of a defined first type or level and includes the basic information or the dog tag information. The first portion may include additional information, as well. The second portion is of a defined second type or level and includes secured information which may only be accessed by an authorized user.

Returning to FIG. 8, in a first step 80A, the portable storage device 12 is inserted into the reader device 30. The reader device 30 sends a reader identification code to the portable storage device 12 in response to the portable storage device 12 being inserted into slot 13 of the reader device 30 in step 80B.

The reader identification code is received at the storage device controller 18 where the reader device 30 is authenticated if the reader identification code is valid in step 80C. If the ID Code is not authentic (step 80D) then the portable storage device 12 is ejected (step 80E).

If the ID Code is authentic, then in step 80F, the portable storage device 12 sends a storage device identification code to the reader device 30. In decision block 80H, if the storage device ID code is not valid, then the storage device is ejects (step 80E). If the storage device ID card is valid, then the method 80 proceeds to step 80I.

In step 80I, a request for access is received by the storage device 12. The request may be generated automatically by the reader device 30 in response to authentication of both ID Codes, an may be generated based on some input from the user on the reader device 30.

In a decision block 80J, if the request is for the first portion of the data (only), then access to the first portion if provided in step 80K. In one embodiment once access is provided it is viewable on the display 40. The display 40 may include a touchscreen device for providing a user interface for navigating through the information or data. Alternatively, or in addition, the reader device 30 may include one or more buttons (not shown) for implementing a user interface which may be used to send data requests, as well as to navigate through the data displayed on the display 40.

In the illustrated embodiment, access to the first portion of the stored information is provided as long as the reader device 30 is valid.

If the request for data is for the second portion of the data, then a request for biometric authentication is sent from the portable storage device 12 to the reader device 30. The reader device 30 then instructs the user to provide the biometric data via the biometric reader 44. If the user is a valid user, i.e., is of the correct type or level to access the second portion of the data, then access to the second portion is provided in step 80O.

While the above method 80 only discusses first and second data portions (having different types), it should be noted that additional data portions may be provided. Each additional data portion may have an associated level or type required to access. Also, a particular level or type of user may be able to access not only the associated data portion, but may also be able to access one or more of the other data portions.

In one aspect of the present invention, the portable storage device 12 may be adapted to receive or accept additional information from the user which may then be sent to, and stored on the portable storage device 12. The portable storage device 12 may include a user interface 13, which, for example, may be implemented by the touchscreen device. The user interface 13 may include a virtual keyboard (not shown), or may accept handwritten notes (input using a stylus 41), or even audio notes. The additional information may be stored in one of the portions of the data based on the type of information and/or the type or level of user.

As discussed above, the reader device 30 shown in FIG. 4 is a general device which may be used by any type of user. It requires only a single portable storage device 12, generally, the patient's device 12 to operate. In general, all of the access templates for all authorized users are stored in memory 16 on the device 12. However, it should be noted that the access templates may be stored off the device 12, for example, on a server which the device 12 may access.

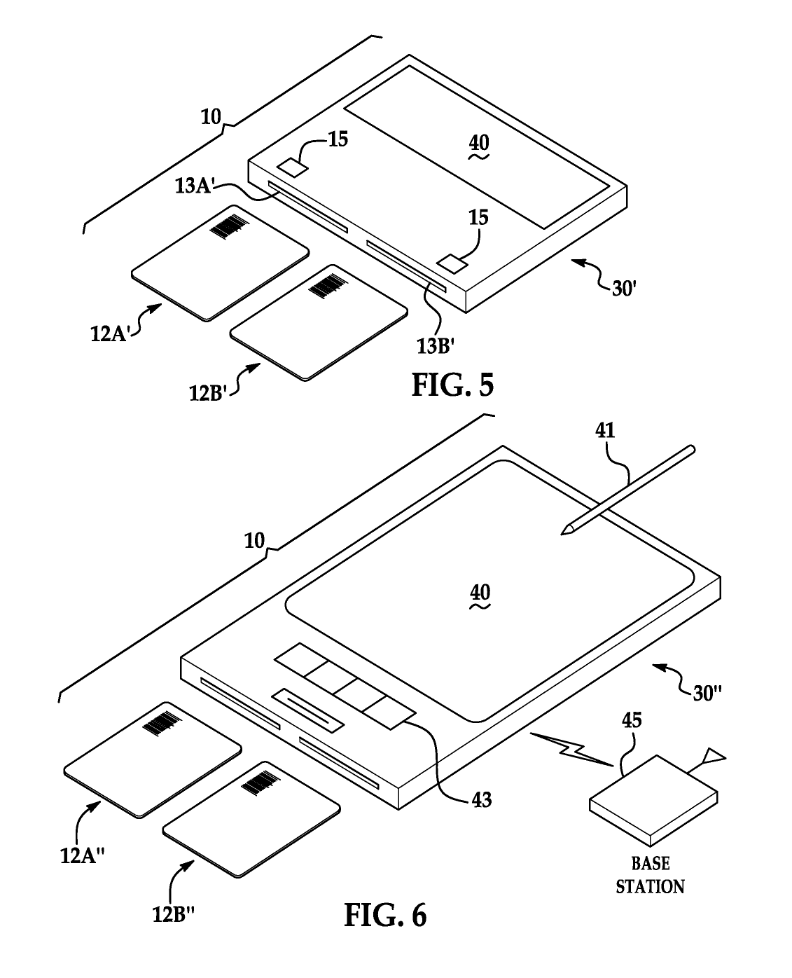

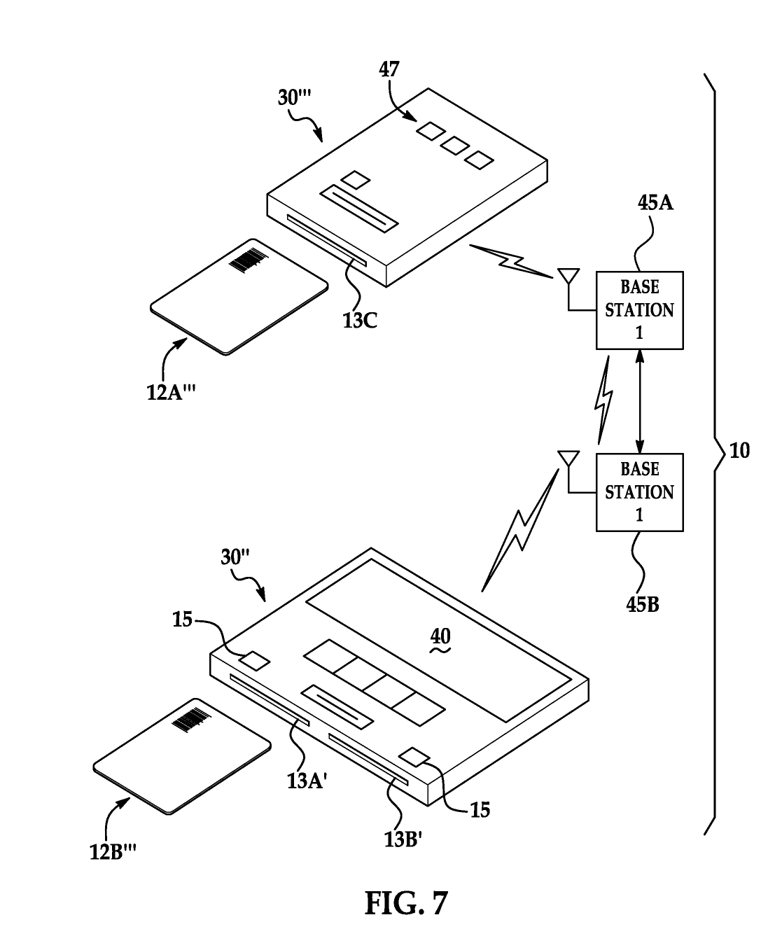

Additionally, it should be noted that the reader 30 may have different forms. Several alternative forms 30′, 30″ are shown in FIGS. 5, 6, and 7.

Additionally, the reader 30, 30′, 30″ may require a second storage device 12B′, 12B″ for user authentication.

Lastly, it should be noted that the various forms of the reader 30′, 30′, 30″ may be adapted to require only the first or patient's card or to require both cards.

With particular reference to FIG. 5, an enhanced reader device 30′ (Reader Type 2), according to an embodiment of the present invention. The enhanced reader device 30′ could be, for example, be issued to, and used by, EMT personnel. To use the enhanced device 30′, a technician portable storage device or card 12B′ is inserted into slot 13B′ and after power on authentication is complete see below), the technician is authenticated and the device 30′ is unlocked and ready for a patient's card 12A′.

When a patient's card 12A′ is inserted into the remaining slot 13A′ the card 12A′ is authenticated (see below) and a session begins. During the session, enhanced patient data is displayed on the display screen 40. When one of a plurality of keys 15 is pressed the session is ended (and the respective device 12A′, 12B′ ejected). When a session ends the display 40 information is cleared and the respective device 12A′, 12B′ ejected. It should be noted that in one embodiment, either device 12A′, 12B′ may be inserted into either slot 13A′, 13B′.

With particular reference to FIG. 6, a “Reader Type 3” or slate reader 30″ is shown. To use the slate reader 30″, a doctor or pharmacist card 12B″ is inserted into either slot 13A′, 13B′ and after power on authentication (see below), the doctor or pharmacist is authenticated using the biometric data from reader 30″ and the device 30″ is unlocked and is ready for a patient card 12A′.

When a patient card 12A′ is inserted into the remaining slot 13A′, 13B′, the card 12A′ is authenticated and a session. During the session, data is displayed on the display 40 and new data is entered using the user interface, for example, by writing on the display screen 40 using stylus 41. Functions for entering prescriptions or communication with associated devices can be selected using one of a plurality of soft keys 43. When a session ends the screen information is captured along with any other information and is saved to the device 12A″ and transmitted to a base station 45 over a wireless connection. Then the patient's card 12A″ is ejected from the “Slate” reader 30″ and returned to the patient.

With respect to FIG. 6, in another aspect of the present invention, a Reader Type 4 or remote reader device 30′″ may be used along with another reader, such as a slate reader 30″ to allow a doctor to access and review a patient's records at hospital or other remote location.

To allow remote access a patient would insert their card 12A′″ into slot 13C of reader 30′″ after power on authentication is complete. The doctor would insert their card 12B′″ into a slate reader 30″ and then press a dedicated function button after power on authentication is complete. This would begin a wireless reader 30″ to its base station 45B authentication process. Once the reader 30″ is authenticated to its base 45B it would send the location of the remote base 45A to its base 45B. Base 45B would then begin the authentication process with the remote base 45A via either a secure wireless or wired connection.

During the connection process the status of the connection would be shown on the indicators 47 on remote device 30′″. Once the connection is complete authentication of the doctor and patient proceeds and a session begins. During this remote session the slate reader 30″ displays the patient's records for the doctor to review and annotate. All transmission between the “devices 30′, 30′″ are encrypted and conform to HIPPA regulations.

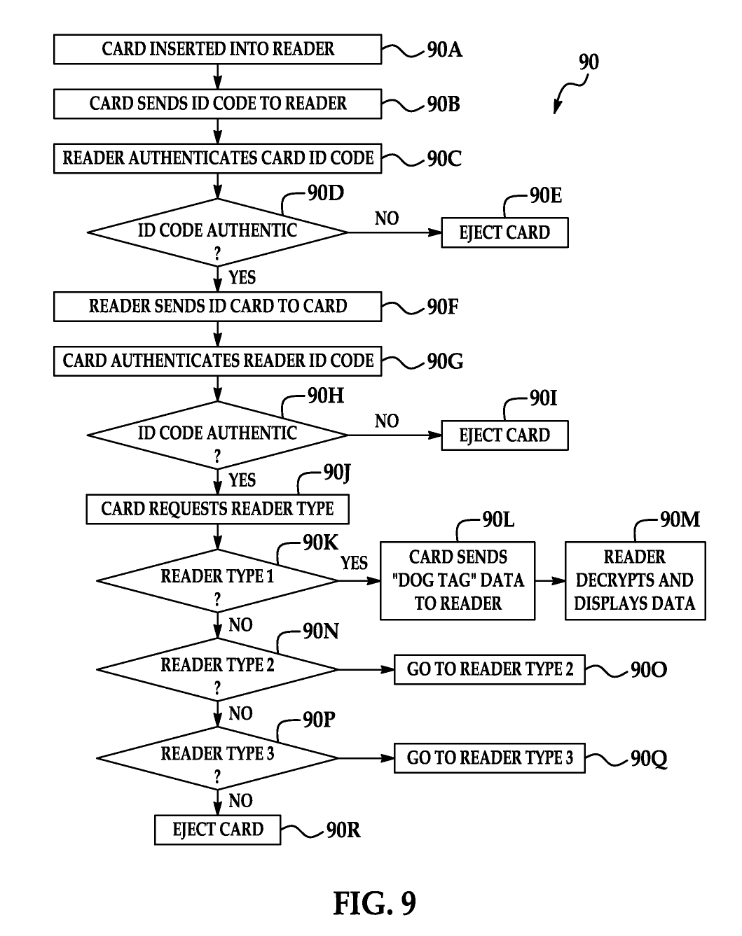

With reference to FIG. 9, a method 90 of operating the system 10, according to another embodiment of the present invention will now be discussed. In a first step 90A, a portable storage device 12, 12′, 12″ in the form of a smart card is inserted into the reader 30, 30′, 30″, 30′″. In the discussion below, unless stated otherwise, reference numbers 12 and 30 will refer to any one of the cards 12, 12′, 12″ or devices 30, 30′, 30″, 30′″.

Once inserted into the reader 30, the card 12 is powered up, and after completing its power on sequence, sends its ID information to the reader 30.

In one embodiment, the ID would be a string with a sequence number or access count with an embedded hash over the string and sequence or count and encrypted with the reader public key. All readers 30 would use a common public/private key pair, and the same would also apply to all cards.

In step 90C, the reader 30 decrypts the received string with its private key, and compares the string value to a list of known responses. A hash of the string over the string and sequence or count would also be done and compared with hash received in the message.

In decision block 90D, if the response and hash are both correct, the card 12 is authentic and execution proceeds to step 90F. Otherwise the card 12 is ejected from the device at step 90E.

In step 90F, the process now repeats, but with the reader 30 sending an ID string with a sequence number or access count with the hash done over the string and sequence or count. The string, sequence or count and hash are encrypted with the cards public key and sent to the to the card.

In step 90G, the card 12 decrypts the received string with its private key, and confirms that the string received is valid, and that the hash over the string and sequence or count is valid.

In decision block 90H, if the string and hash values are valid, execution proceeds to 90J otherwise, the card 12 would shut down and be ejected from the reader device 30.

In step 90J, the card 12 then requests the readers type, basic, enhanced, etc. The reader types are separate from the authentication strings, and may either be strings or numeric values. This information is used by the card to determine the data the card will allow access too. All requests and responses between the card and reader are encrypted. The same key pairs that were used in the authentication could be used, but the preferred method would use a different key, or method than that used in the authentication process.

This method would be used in all subsequent transactions.

In step 90K, if the reader is a type 1 (basic), the card will send basic patient information to the reader (step 90L). This response would be encrypted as mentioned above.

In one embodiment, the ‘dog tag’ information would consist of the name, blood type, and any known conditions the patient may have; Diabetes, epilepsy, drug allergies etc. Note: This information may also be encoded in the form of a QR code that would be printed on the back of the card, for reading by smart phone devices with the proper software installed, if a reader is not available.

The reader 30 would then decrypt this information and display it on the readers screen 40 in step 90M.

In decision block 90N if the device 12 is a reader type 2 device, the method decrypt this information and display it on the readers screen 40 in step 90O. This type 2 or enhanced reader would display all of the type 1 or basic information, but would also expand on that to show active prescriptions doctor information or conditions not allowed in the type 1 display.

In decision block 90P if the device 12 is a reader type 3 device, the method proceeds to step 90Q. The type 3 or doctor device, would be capable of accessing the entire patient treatment history. This history would include medications prescribed, x rays, treatments by other doctors etc. While the other readers are read only devices, this device has the capability to write updated records to the card.

In step 90R, the session ends when the card is ejected.

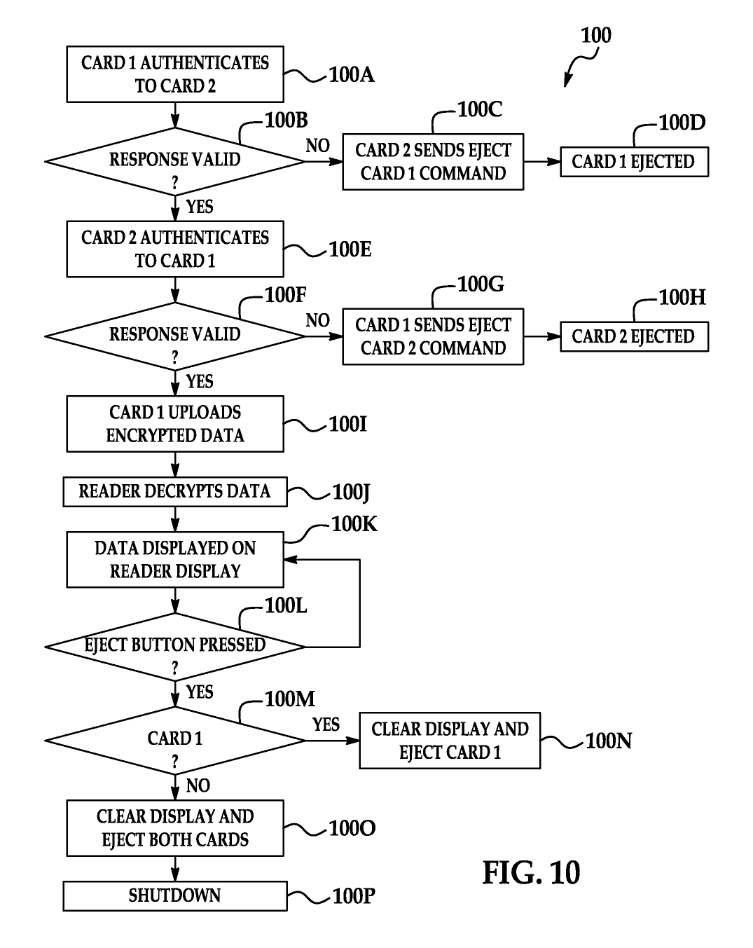

With respect to FIG. 10, operation of the Type 2 or enhanced reader 30′ will now be discussed. Card 1 and first card refer to the patient card 12A′. Card 2 and second card refer to the technicians or nurses card 12B′.

Once the hardware authentication is complete (see below), the cards 12A′, 12B′ will authenticate themselves to each other. This starts with the first card 12A′ sending an encrypted ID string with a sequence number or access count with an embedded hash over the string and sequence or count (step 100A). The common card key pair will be used for all transactions. The reader in these transactions only serves as a communication bridge for the authentication.

In decision block 100B, if the second card 12B′ successfully decrypts and decodes the ID sent by the first card 12A′, it begins the authentication process with the first card 12A′ being the authenticator.

If authentications fails though, the second card 12B′ instructs the device to shutdown and eject the first card 12A′ (steps 100C, 100D).

In step 100E, the second card 12B′ authenticates to the first card 12A′. This process is the same as the process used with the first card 12A′. The second card 12B′ sends an encrypted ID containing a string, a sequence number or count and a hash over the string and numeric value.

In decision block 100F, if the first card 12A′ successfully decrypts and decodes the ID sent by the second card 12B′ execution proceeds to 100I otherwise execution proceeds to 100G.

In step 100G, the first card 12A′ instructs the device 30 to shutdown and eject the second card 12B′ (steps 100G, 100H).

Now, since hardware and card authentication is complete, the first card can begin uploading the enhanced patient data to the reader (step 100I).

In step 100J, the reader 30′ decrypts the data stream from the first card 12A′ and the data is displayed on the display 40 (step 100K).

After decrypting the data stream and displaying, it the device waits for an eject pressed (decision block 100L).

Once an eject button has been depressed, in decision block 100M, if the source of the eject event, was the first card 12A′, then the display 40 (and its buffer) is cleared and the first card 12A′ is ejected (step 100N).

If the source was from the second card 12B′, then the display 40 (and its buffer) is cleared and both cards 12A′, 12B′ are ejected (step 100O) and the device 30′ is shutdown (step 100P).

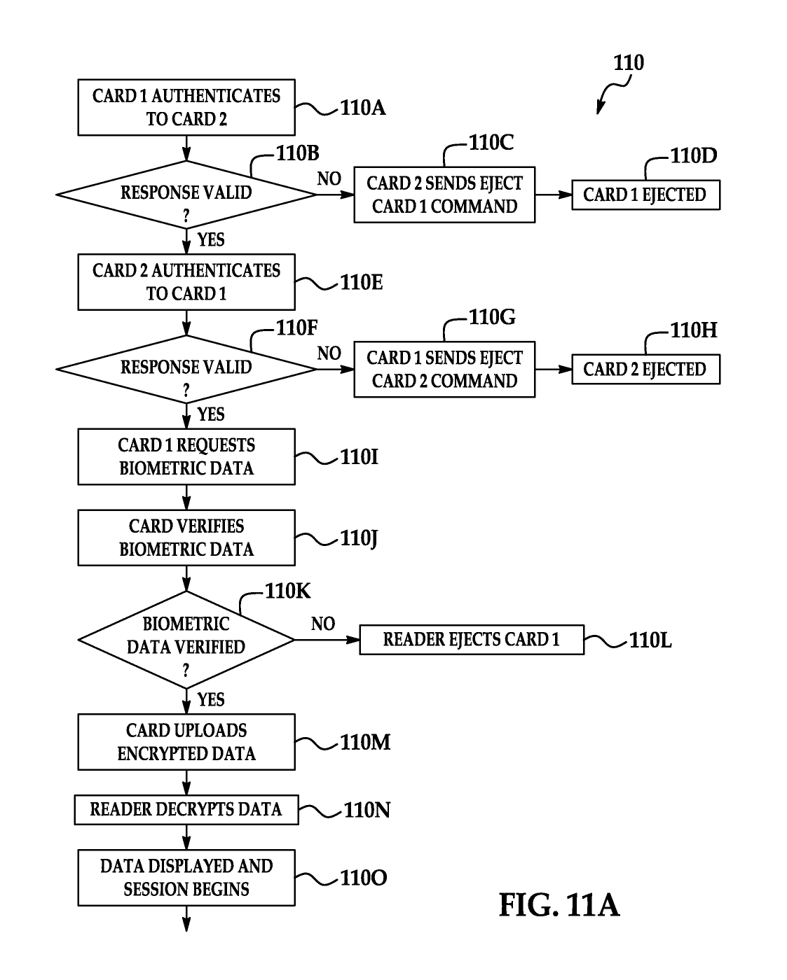

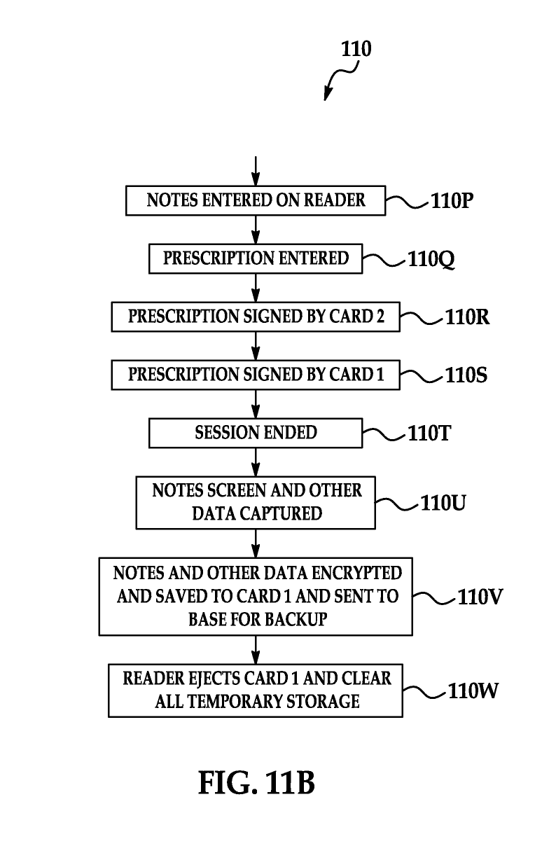

With reference to FIGS. 11A and 11B, operation of a type 3 or slate reader 30″ will now be discussed (method 110). Card 1 and first card refer to the patient card 12A″. Card 2 and second card refer to the doctors or nurses card 12B″.

In step 110A, once the hardware authentication is complete, the cards 12A″, 12A″ will authenticate themselves to each other. This starts with the first card sending an encrypted ID string with a sequence number or access count with an embedded hash over the string and sequence or count. The common card key pair will be used for all transactions. The reader in these transactions only serves as a communication bridge for the authentication.

In decision block 110B, if the second card 12B″ successfully decrypts and decodes the ID sent by the first card 12A″, it begins the authentication process with the first card 12A″ being the authenticator.

In step 110C, if authentications fails though, the second card 12B″ instructs the device 30″ to shutdown and eject the first card 12A″ (step 110D).

In step 110E, the process is the same as the process used with the first card 12A″. The second card 12B″ sends an encrypted ID containing a string, a sequence number or count and a hash over the string and numeric value.

In decision block 110F, if the first card 12A″ successfully decrypts and decodes the ID sent by the second card 12B″ execution proceeds to 110I otherwise execution proceeds to 110G.

In step 110G, the first card 12A″ instructs the device 30″ to shutdown and eject card 2 12B″ (step 110H).

Once all authentications (step 110I) are complete, the first card 12A″ instructs the device 30″ to enable the biometric reader on the device 30″ and to begin sending biometric information to the card 12A″.

In step 110J, the first card 12A″ then compares the received data to the templates it has stored. In step 110K, if the received biometric data matches one of the stored templates, execution moves to step 110M. If there is no match execution proceeds to step 110L.

In step 110L, biometric authentication has failed, the card 12A″ sends an eject signal to the device 30″, which shuts it down and ejects the card 12A″.

If biometric authentication was successful, the card 12A″ now begins uploading the encrypted patient data (step 110M).

In step 110N, the reader 30″ decrypts and displays the patient data (step 100O).

Once the initial patient data is uploaded and displayed, the doctor sessions begins. Here the doctor can move through the history of the patient. In addition to moving through the patients history the doctor can also include their own notes in the record, using voice, keyboard or stylus. These notes will be written to the card prior to the ending of the session (steps 110P, 110Q). The doctor enters any notes on the screen of the reader, using a keyboard, voice or pen. If a prescription is to be issued, the doctors goes to a prescription page, where the prescription information is entered. This page will also show the patients prescription history and indicate if any similar prescriptions were entered by other doctors.

Once the prescriptions details are entered, the doctor electronically signs the prescription using authentication information from the second card 12B″ (step 110R).

The prescription is then countersigned using authentication from the first card 12A″ (step 110S).

In step 110T, the doctor ends the session. The notes and any data entered during the session are captured and save in isolated storage on the card 12A″ (step 110U).

The data captured in step 110U is encrypted and sent to a base station for off site backup and is saved to the cards permanent record (step 110V).

With the session ended and all storage functions complete, the card sends an eject signal to the device (110W). On receipt of the eject signal the device's display and its buffer and any temporary storage are cleared and the card is ejected.

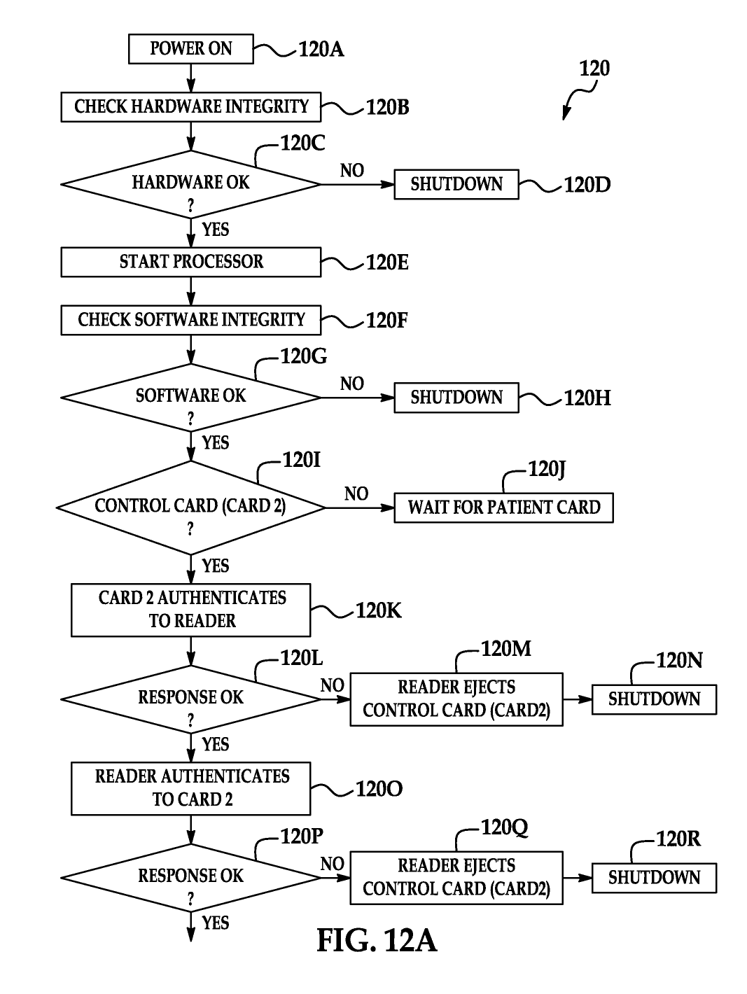

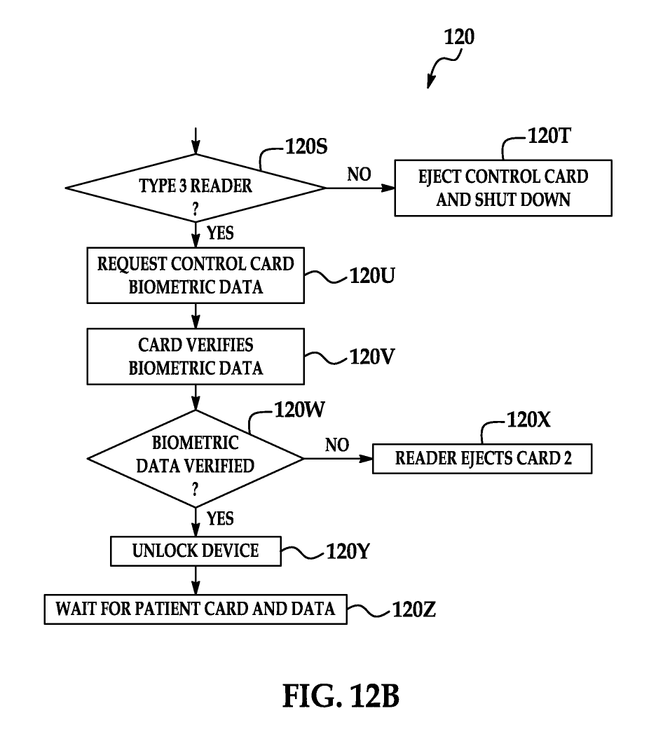

With reference to FIGS. 12A and 12B, operation of a Type 3 reader/remote operation will now be discussed (method 120). The control card or card 2 refers to the doctors card 12B′″.

In step 120A, the reader device 30″ is powered on, through a soft key or by plugging in a power connection. In step 120B, the device 30″ powers the case tampering loops. These are conductive loops in the device case to detect physical tampering with the device.

In step 120C, if breaks are detected in the loops execution proceeds to 120D, otherwise execution continues to 120E.

In step 120D, the device 30″ turns its self off.

In step 120E, the loops were intact, power is switched to the rest of the device 30″.

In step 120F, the processor performs validation testing of the device's software. This validation would include all control code, and verification of temporary storage.

In decision block 120G, if the software successfully completed the validation procedure then proceed to 120I otherwise proceed to 120H.

In step 120H, the software or memory failed validation, the device turns its self off.

In decision block 120I, the presence of a control card 12B′″ is checked for. If none is found, then the method 120 waits for a patient card (step 120J). The patient card 12A′″ would already be authenticated on its device 30′″.

In step 120K, once the control card 12B′″ is inserted, the card 12B′″ authenticates to its reader 30″ using a string and sequence number or access count hashed together and then the string sequence number or counter and the hash are encrypted using the reader common public key.

In decision block 120L, if the reader 30″ is successful in validating the card execution proceeds to 120O, otherwise execution proceeds to 120M.

In step 120M, If validation failed the reader 30″ shuts the card down and ejects it.

In step 120N, after ejecting the card 12B′″, the device 30″ powers itself down.

In step 120O, after successfully validating the card 12B″ the device 30″ then validates itself to the card 12B″ using the same method as the card validation shown in step 120K.

In decision block 120P, if the card 12B″ is successful in validating the reader execution proceeds to 120S, otherwise execution continues with 120Q.

In step 120Q, validation was unsuccessful, thus, the card 12B″ signals the device 30″ to shutdown and eject the card 12B″.

In step 120R, after ejecting the card 12B″, the device 30″ powers itself down.

In decision block 120S, the card queries the reader for its type. If it is a type 3 reader execution proceeds with 120U. Otherwise execution proceeds to 120T.

In step 120T, since the reader type is incorrect, the card 12B″ sends an eject signal to the device 30″. The device 30″ then shuts the card down and ejects it.

In step 120U, since the device type is correct, the card instructs the device to enable the biometric reader on the device 30″ and to start sending sensed biometric data to the card 12B″.

In step 120V, when the reader 30″ is finished sending data to the card 12B″, it compares the received data to the templates stored on the card.

In decision block 120W, if the received biometric data matches a template stored on the card, execution proceeds to 120Y.

If the biometric data received does not match any of the stored templates, the card sends an eject signal to the device, shutting the card down and ejecting it (step 120X).

In step 120Y, the biometric authentication was successful, so the card 12B″ will instruct the device 30″ to unlock its display 40.

In step 120Z, all of the local authentications and validations are complete. If patient data is available it is decrypted and displayed on the local device, otherwise wait for the stream from device 30′″.

Any modifications and variations of the present invention are possible in light of the above teachings. The invention may be practiced otherwise than as specifically described within the scope of the appended claims.

What is claimed is:

1. A method for providing access to information stored on a portable storage device via a reader device, the portable storage device for storing information, the information including user data associated with a user, the user data having a first portion and a second portion, the first portion being of a first type, the second portion being of a second type, and a storage device controller located within the housing and being coupled to the memory storage, comprising:
allowing the portable storage device to be inserted into a reader device;
sending a reader identification code from the reader device to the portable storage device in response to the portable storage device being inserted into the reader device;
receiving the reader identification code at the storage device controller, authenticating the reader device if the reader identification code is valid, and responsively ejecting the portable storage device if the reader identification code is not valid;
sending a portable storage device identification code from the portable storage device to the reader device;
receiving the portable storage device identification code at the reader device, authenticating the portable storage device if the portable storage device identification code is valid, and responsively ejecting the portable storage device if the portable storage identification code is not valid; and,
if the reader identification code and the portable storage device identification code are valid:
providing access to the first portion of the user data stored on the portable storage device; and,
receiving a request for the second portion of the information stored on the reader device by a requesting user, responsively requiring biometric authentication of the requesting user, and responsively providing access to the second portion of the user data stored on the portable storage device if the requesting user is authenticated.

2. A method, as set forth in claim 1, biometric template data being stored on the memory storage for a plurality of authorized users of the second type of data, the reader device including a reader located within the reader device housing for connecting to the storage device, and, a reader device controller located within the reader device housing and being coupled to the reader, for allowing communications with the storage device controller, wherein the step of requiring biometric authentication of the requesting user includes the steps of:
reading a biometric parameter of the requesting user via the reader;
sending biometric information related to the biometric parameter to the portable storage device controller;
comparing the biometric information related to the biometric parameter of the requesting user; and,
authenticating the requesting user if the biometric information matches biometric template data of one of the authorized users of the second type of data.

3. A method, as set forth in claim 1, wherein the step of receiving a request for the second portion of the information includes the step of rejecting access to the second portion of the user data stored on the portable storage device if the requesting user is not authenticated.

4. A method, as set forth in claim 1, wherein the user data includes a third portion, the method including the step of a request for the third portion of the information stored on the reader device by a second requesting user, responsively requiring biometric authentication of the second requesting user, and responsively providing access to the third portion of the user data stored on the portable storage device if the second requesting user is authenticated.

5. A method, as set forth in claim 4, wherein the step of receiving a request for the third portion of the information includes the step of rejecting access to the third portion of the user data stored on the portable storage device if the second requesting user is not authenticated.

6. A method, as set forth in claim 1, wherein the biometric authentication is based on at least one of a fingerprint, a voice recording, and an iris of an eye.

7. A method, as set forth in claim 1, wherein the portable storage device is a card, the storage device controller includes a processor and memory, the method including the step of storing the user data in the memory.

8. A method, as set forth in claim 1, wherein the memory includes a dynamically allocated first block of memory and a dynamically allocated second block of memory, the first portion of the user data being stored in the first block of memory, the second portion of the user data being stored in the second block of memory.

9. A method, as set forth in claim 1, the reader device including a display, the method including the step of displaying the first portion and/or the second portion on the display.

10. A method, as set forth in claim 1, the reader device having a user interface for receiving additional information related to the user, the method includes the steps of:
sending the additional information to portable storage device, and,
storing the additional information on the portable storage device.

11. A method, as set forth in claim 10, wherein the additional information may be designated as being of the basic type or the second type.

12. A method for providing access to medical records associated with a patient stored on a portable storage device via a card reader, the card including a memory storage for storing information, the medical records being associated with a user, the medical records having a first portion and a second portion, the first portion being of a basic type, the second portion being of a second type, and a storage device controller located within the housing and being coupled to the memory storage, comprising:
allowing the card to be inserted into the card reader;
sending a reader identification code from the card reader to the card in response to the card being inserted into the card reader;
receiving the reader identification code at the storage device controller, authenticating the card reader if the reader identification code is valid, and responsively ejecting the card if the reader identification code is not valid;
sending a card identification code from the card to the card reader;
receiving the card identification code at the card reader, authenticating the card if the card identification code is valid, and responsively ejecting the card if the portable storage identification code is not valid; and,
if the reader identification code and the card identification code are valid:
providing access to the first portion of the medical records stored on the portable storage device; and,
receiving a request for the second portion of the information stored on the card reader by a requesting user, responsively requiring biometric authentication of the requesting user, and responsively providing access to the second portion of the medical records stored on the card if the requesting user is authenticated.

13. A method, as set forth in claim 12, biometric template data being stored on the memory storage for a plurality of authorized users of the second type of data, the card reader including a reader located within the card reader housing for connecting to the storage device, and, a card reader controller located within the card reader housing and being coupled to the reader, for allowing communications with the storage device controller, wherein the step of requiring biometric authentication of the requesting user includes the steps of:
reading a biometric parameter of the requesting user via the reader;
sending biometric information related to the biometric parameter to the card controller;
comparing the biometric information related to the biometric parameter of the requesting user; and,
authenticating the requesting user if the biometric information matches biometric template data of one of the authorized users of the second type of data.

14. A method, as set forth in claim 12, wherein the step of receiving a request for the second portion of the information includes the step of rejecting access to the second portion of the medical records stored on the card if the requesting user is not authenticated.

15. A method, as set forth in claim 12, wherein the medical records includes a third portion, the method including the step of a request for the third portion of the information stored on the card reader by a second requesting user, responsively requiring biometric authentication of the second requesting user, and responsively providing access to the third portion of the medical records stored on the card if the second requesting user is authenticated.

16. A method, as set forth in claim 15, wherein the step of receiving a request for the third portion of the information includes the step of rejecting access to the third portion of the medical records stored on the card if the second requesting user is not authenticated.

17. A method, as set forth in claim 12, wherein the biometric authentication is based on at least one of a fingerprint, a voice recording, and an iris of an eye.

18. A method, as set forth in claim 12, wherein the card is a card, the storage device controller includes a processor and memory, the method including the step of storing the medical records in the memory.

19. A method, as set forth in claim 12, wherein the memory includes a dynamically allocated first block of memory and a dynamically allocated second block of memory, the first portion of the medical records being stored in the first block of memory, the second portion of the medical records being stored in the second block of memory.

20. A method, as set forth in claim 12, the card reader including a display, the method including the step of displaying the first portion and/or the second portion on the display.

21. A method, as set forth in claim 12, the card reader having a user interface for receiving additional information related to the user, the method includes the steps of:
sending the additional information to portable storage device, and,
storing the additional information on the portable storage device.

22. A method, as set forth in claim 21, wherein the additional information may be designated as being of the basic type or the second type.
